(19) United States
(12) Patent Application Publication
(10) Pub. No.: US 2019/0390082 A1
(43) Pub. Date: Dec. 26, 2019

(54) WATER-SOLUBLE COATING LIQUID AND POLYESTER OPTICAL FILM COATED WITH THE WATER-SOLUBLE COATING LIQUID

(71) Applicant: NAN YA PLASTICS CORPORATION, Taipei (TW)

(72) Inventors: TE-CHAO LIAO, TAIPEI (TW); CHUN-CHE TSAO, TAIPEI (TW); WEN-JUI CHENG, TAIPEI (TW); CHENG-HUNG CHEN, TAIPEI (TW)

(21) Appl. No.: 16/448,852

(22) Filed: Jun. 21, 2019

(30) Foreign Application Priority Data
Jun. 26, 2018 (TW) 107121926

(51) Int. Cl. C09D 175/16; C08J 7/04; C08L 75/16; C09D 7/61; C09D 7/40; C09D 7/20; G02B 1/14

(52) U.S. Cl. CPC C09D 175/16; C08J 7/04; C08L 75/16; C09D 7/61; C09D 7/68; C08K 3/22; C09D 7/20; G02B 1/14; C08J 2367/00; C08J 2475/16; C09D 7/69

(57) ABSTRACT

The present invention provides an acrylate graft-modified polyurethane resin and surface-modified inorganic particles to improve a compatibility between the polyurethane resin and the inorganic particles, so that the inorganic particles are uniformly dispersed between the modified polyurethane resins, and that a coating of the polyester optical film has excellent adhesion resistance and slip resistance.

### CROSS-REFERENCE TO RELATED PATENT APPLICATION

This application claims the benefit of priority to Taiwan Patent Application No. 107121926, filed on Jun. 26, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference is individually incorporated by reference.

### FIELD OF THE DISCLOSURE

The present disclosure relates to a water-soluble coating liquid for coating a surface of a polyester film substrate to form a coating, and more particularly to a polyester optical film coated with said coating, which not only has high transparency and low haze but also has excellent adhesion resistance and slip resistance.

### BACKGROUND OF THE DISCLOSURE

A backlight module substrate of a liquid crystal display, for example, a diffusion film or a brightness enhancement film, is made of a polyester optical film such as a biaxially stretched PET optical film. Transparency, haze and slipperiness of the polyester optical film are related to a degree of crystallization of the polyester optical film, type and content of an added micron-sized lubricant, as well as physical properties of a coating applied to a polyester film substrate. In the coating, aside from the polyester resin, fine inorganic particles are added to improve the slipperiness of a polyester film. In addition to the refractive index and surface flatness of the coating affect the transparency of the polyester optical film, a degree of dispersion of the fine inorganic particles in the coating also affects the transparency of the polyester optical film.

Conventional polyurethane resins have disadvantages of low mechanical strength, UV light resistance, heat resistance, and water resistance. In particular, when the coating of the polyester optical film contains a urethane resin and fine inorganic particles, the compatibility between the urethane resin and the inorganic particles is poor. If the inorganic particles are dispersed unevenly, agglomeration occurs. For example, in China Patent Publication No. CN103171223 A1, a polyester optical film with high transparency and good adhesion resistance is disclosed, and the coating liquid thereof includes an aqueous polyurethane resin and uses 0.04-6 μm fine inorganic particles, but the inorganic particles may be unevenly dispersed between the polyurethane resins so that agglomeration may occur. When the polyester optical film is stretched, the agglomeration of the coating causes voids around the agglomerated inorganic particles, resulting in poor surface flatness of the coating. These factors affect the transmittance, haze and slipperiness of the polyester optical film.

When the backlight module substrate for the liquid crystal display is used, the coating of the polyester optical film must have excellent adhesion to both the polyester film substrate having the coating, and a UV curing high refractive index acrylate resin of a liquid crystal display material (hereinafter referred to as LCD material).

However, if the coating of the polyester optical film is a pure acrylate resin, the coating has good weatherability, but has poor adhesion to a UV curing high refractive index acrylate resin in the LCD material and the polyester film substrate. Similarly, if the coating of polyester optical film is a pure polyester resin, the coating has good adhesion to the polyester film substrate, but has poor adhesion to UV curing acrylate resin in the LCD material.

In addition, the coating of the polyester optical film is coated on one or both sides of the polyester film substrate. If the coating does not have excellent adhesion resistance, the polyester optical film tends to stick together during winding, which will affect subsequent processing, tailoring or packaging of the polyester optical film. In particular, when the surface of the polyester optical film is adhered, white fog, streaks, and fine crystal dots are formed, which may affect the appearance and application of the polyester optical film.

More specifically, as being a backlight module substrate of the liquid crystal display, the polyester optical film is required to have a coating with excellent adhesion resistance and slip resistance.

### SUMMARY OF THE DISCLOSURE

In response to the above-referenced technical inadequacies, the present disclosure provides an acrylate graft-modified polyurethane resin and surface-modified inorganic particles to improve a compatibility between the polyurethane resin and the inorganic particles, so that the inorganic particles are uniformly dispersed between the modified polyurethane resins, and that a coating of the polyester optical film has excellent adhesion resistance and slip resistance.

In one aspect, the present disclosure provides a water-soluble coating liquid for coating a surface of a polyester film substrate to form a coating, including the following components in a weight ratio, and the sum of the following components is 100 wt %:

(1) 2 to 40 wt % of an acrylate graft-modified polyurethane resin;

(2) 0.5 to 30 wt % of a crosslinking agent;

(3) 0.05 to 30 wt % of filler particle mixture;

(4) 0.05 to 10 wt % of an additive selected from one or any combination of an auxiliary agent, a catalyst and a co-solvent; and

(5) 50 to 85 wt % of water;

In certain embodiment, the component of the filler particle mixture of the component (3) includes:
a. 20 to 95 wt % of inorganic particles selected from one or any combination of silicon oxide, titanium oxide, aluminum oxide, calcium carbonate, calcium phosphate and barium sulfate; and
b. 0.5 to 30 wt % of surface modifier to modify a surface of the inorganic particles.

In certain embodiments, the inorganic particles of the component (3) have a particle size of from 0.005 to 3 μm.

In certain embodiments, a surface-modified inorganic particle concentration is from 0.01% to 6% of the solid content of the water-soluble coating liquid.

In certain embodiments, the acrylate graft-modified polyurethane resin is graft-modified using an acrylate monomer composed of the following components, and the sum of the following components is 100 wt %:
a. 90 to 95 wt % of alkyl group-containing (meth)acrylate;
b. 4 to 9 wt % of hydroxyl group-containing (meth)acrylate; and
c. 1 to 5 wt % of carboxyl group-containing vinyl monomer, selected from one or any combination of acrylic acid, methacrylic acid, itaconic acid, crotonic acid, maleic acid, fumaric acid, and maleic anhydride.

In certain embodiments, the crosslinking agent of the component (2) is selected from one or any combination of melamine crosslinking agent, hydroxymethyl modified melamine derivative crosslinking agent, isocyanate crosslinking agent, aziridine crosslinking agent, oxazoline crosslinking agent and carbodiimide crosslinking agent.

In certain embodiments, the surface modifier of the component (3) is selected from one or any combination of vinyl decane coupling agent, epoxy decane coupling agent, styryl decane coupling agent, methyl propylene decyl decane coupling agent, propylene decyl decane coupling agent, amino decane coupling agent, isocyanurate decane coupling agent, ureido decane coupling agent and isocyanate decane coupling agent.

In certain embodiments, the auxiliary agent in the component (4) is selected from one or any combination of silicon-containing additive, fluorine-containing additive, and additive containing a silicon/fluorine mixed component.

In certain embodiments, the co-solvent in the component (4) is selected from one or any combination of methanol, ethanol, n-propanol, isopropanol, butanol, isobutanol, dimethylhydrazine, acetone and tetrahydrofuran solvent.

In one aspect, the present disclosure provides a polyester optical film having a biaxially stretched polyester film substrate, and a surface of the substrate is coated with water-soluble coating liquid of the present disclosure to form a coating, which can significantly improve transparency, haze, adhesion, slip and anti-stick properties of polyester optical film.

Therefore, the beneficial effects of the present disclosure include:
1. The polyester optical film coating has excellent adhesion resistance and slip resistance.
2. The polyester optical film is easy to roll and not sticky after coating the coating, which is beneficial for subsequent processing, cutting or packaging.
3. The polyester optical film has high transparency and low haze, and is suitable as a backlight module substrate for liquid crystal displays, for example a diffusion film, a brightness enhancement film, an anti-reflection film, and a protective film.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure provides a water-soluble coating liquid for coating a surface of a polyester film substrate to form a coating of a polyester optical film, including the following components in a weight ratio, and the sum of the following components is 100 wt %:
(1) 2 to 40 wt % of an acrylate graft-modified polyurethane resin;
(2) 0.5 to 30 wt % of a crosslinking agent;
(3) 0.05 to 30 wt % of filler particle mixture;
(4) 0.05 to 10 wt % of an additive selected from one or any combination of an auxiliary agent, a catalyst and a co-solvent; and
(5) 50 to 85 wt % of water;

The component of the filler particle mixture of the component (3) includes:
a. 20 to 95 wt % of inorganic particles selected from one or any combination of silicon oxide, titanium oxide, aluminum oxide, calcium carbonate, calcium phosphate and barium sulfate; and
b. 0.5 to 30 wt % of surface modifier to modify a surface of the inorganic particles.

A surface-modified inorganic particle concentration is from 0.01% to 6% of the solid content of the water-soluble coating liquid.

Regarding the acrylate graft-modified polyurethane resin of the component (1), the synthesis method thereof includes the following steps, based on the total amount of reactive materials, including deionized water:

1. Preparation of Prepolymer:

15-25% by weight of polyester (ether) polyol is vacuum dehydrated, and is then is added to the reactor equipped with a stirrer, thermometer and condenser tube. When the oil bath temperature reaches 70-80° C., an aliphatic diisocyanate of 5 to 12 wt % is added to carry out a synthesis reaction.

2. Dilution and Chain Extension of Prepolymer:

After the prepolymer is reacted for 2-3 hours, 10-30 wt % of acrylate monomer is added to reduce the viscosity, and the temperature is maintained at 85-90° C. until the theoretical equivalent ratio of NCO (NCO/OH) is 1.1 to 2.3, and then 1.5-3.0 wt % of sodium ethylenediamine ethanesulfonate (AAS) is added and continuingly reacted for 25-40 minutes.

3. Water Dispersion:

The polymer obtained by the reaction of step 2 is cooled to room temperature, and 35 to 55 wt % of deionized water is added under high-speed shearing force of 500 rpm, and then 0.1-0.5 wt % of ethylenediamine is added for chain extension. The chain extension reacts for about 30 minutes to prepare a solvent-free sulfonate-type aqueous polyurethane dispersion.

4. Acrylate Synthesis:

The sulfonate-type aqueous polyurethane dispersion of step 3 is added with 0.3 to 1.0 wt % of sodium dodecyl sulfate (SLS) emulsifier to form an emulsion, the temperature is raised to 50 to 70° C., and then a 0.01 to 0.10 wt % aqueous solution of ammonium persulfate (APS) is added dropwise to polymerize the acrylate. Later, the temperature is raised to 75-85° C., and the temperature is maintained at this temperature for 1 to 3 hours. After cooling to 50 to 70° C., 0.01-0.08 wt % of a reducing agent is added to prepare the acrylate graft-modified polyurethane resin.

The acrylate graft-modified polyurethane resin (monomer) is composed of the following components, and the sum of the following components is 100 wt %:
a. 90 to 95 wt % of alkyl group-containing (meth)acrylate;
b. 4 to 9 wt % of hydroxyl group-containing (meth)acrylate; and
c. 1 to 5 wt % of carboxyl group-containing vinyl monomer.

The alkyl group-containing (meth)acrylate is selected from one or any combination of methyl (meth)acrylate, ethyl (meth)acrylate, propyl (meth)acrylate, n-butyl (meth)acrylate, isobutyl (meth)acrylate, (meth)acrylic acid-2-ethylhexyl ester, n-octyl (meth)acrylate, isooctyl (meth)acrylate, lauryl (meth)acrylate, octadecyl (meth)acrylate, cyclohexyl (meth)acrylate, (methyl) methoxyethyl acrylate and ethoxymethyl (meth)acrylate.

The hydroxyl group-containing (meth)acrylic acid is selected from one or any combination of 2-hydroxyethyl (meth)acrylate, 4-hydroxybutyl (meth)acrylate, chloro-2-hydroxypropyl acrylate, diethylene glycol mono(meth)acrylate and allyl alcohol.

The carboxyl group-containing vinyl monomer is selected from one or any combination of acrylic acid, methacrylic acid, itaconic acid, crotonic acid, maleic acid, fumaric acid and maleic anhydride.

The crosslinking agent of the component (2) is selected from one or any combination of melamine crosslinking agent, hydroxymethyl modified melamine derivative crosslinking agent, isocyanate crosslinking agent, aziridine crosslinking agent, oxazoline crosslinking agent and carbodiimide crosslinking agent.

The inorganic particles in the filler particle mixture have a particle size of 0.005 to 3 μm. Based on the physical properties of the polyester optical film, such as transparency, haze, slipperiness or anti-sticking properties, the inorganic particles in the filler particle mixture can be combined with inorganic particles of different sizes. When the particle size of the inorganic particles is larger, the coating of the polyester optical film has a better anti-sticking effect at a high temperature. When the dispersion of the inorganic particles is better, the inorganic particles are less likely to agglomerate, the polyester optical film and its coating are more transparent, and the haze is lower.

The surface modifier in the filler particle mixture is selected from one or any combination of vinyl decane coupling agent, epoxy decane coupling agent, styryl decane coupling agent, methyl propylene decyl decane coupling agent, propylene decyl decane coupling agent, amino decane coupling agent, isocyanurate decane coupling agent, ureido decane coupling agent and isocyanate decane coupling agent.

After the inorganic particles are modified by the surface modifier, the particles can be agglomerated, the dispersion is poor, the compatibility is low, and the adhesion is low. In particular, the inorganic particles can form microspheres in the coating and are slightly convex, thus effectively improving the anti-sticking effect of the coating of the polyester optical film. When winding, the inorganic particles are slightly convex on the surface of the coating, such that the polyester optical film forms an air layer between the films in a wound state. The air layer can reduce a friction coefficient and adhesion between each film, thereby avoiding sticking phenomenon between the films, and solving the problem that the polyester optical film sticks easily.

The additive of component (4) is selected from one or any combination of the auxiliary agent, the catalyst and the co-solvent. The additive can adjust the surface tension of the coating liquid, improve flatness of the coating (or coating film) of the polyester optical film, and wettability between the polyester substrates. Adding the catalyst can control a bridging reaction rate of the coating liquid. The addition of the co-solvent controls a rate of volatilization of the liquid components in the coating.

The catalyst is an inorganic substance, a salt, an organic substance, a basic substance or an acidic substance. The co-solvent is one or more of methanol, ethanol, n-propanol, isopropanol, butanol, isobutanol, dimethyl hydrazine, acetone and tetrahydrofuran solvent.

The auxiliary agent includes a silicon-containing additive, a fluorine-containing additive, or an additive containing a silicon/fluorine mixed component.

The silicon-containing additive is selected from one or any combination of BYK307, BYK325, BYK331, BYK380N and BYK381 of BYK Company.

The fluorine-containing additive is selected from one or any combination of FC-4430 and FC-4432 of 3M Company, Zonyl FSN-100 of DuPont Company of the United States and DSX of Daikin Corporation of Japan.

The additive containing a silicon/fluorine mixed component is selected from one or any combination of BYK346, BYK347 and BYK348 of BYK Company.

The water-soluble coating liquid (or coating) of the present disclosure may be coated on the surface of the polyester film substrate to form a polyester optical film by off-line or in-line coating. Moreover, the obtained polyester optical film has high transparency, low haze, excellent adhesion resistance and slip resistance, and is suitable for applying to a diffusion film, a brightness enhancement film, or a protective film for an LCD or a CRT.

The polyester optical film (abbreviated as optical film) of each of the following embodiments and comparative examples is evaluated in accordance with the following evaluation methods.

I. Light Transmittance and Haze Test:

The optical transmittance and haze value of the optical film samples are tested using a Model TC-HIII haze meter from Tokyo Denshoku Co., Ltd. in accordance with JIS K7705. The higher the light transmittance is and the lower the haze value is, the better the optical properties of the optical film are.

II. Optical Adhesive Adhesion Test:

A Model F300S+AJ-6-UVL exposure machine from InVisage Technologies is used to test adhesion of the coated surface of an optical film sample to an acrylate UV adhesive for a diffusion film and a brightness enhancement film, and the test is in accordance with the ASTM D3359 standard. The optical adhesive for domestic diffusion film or brightness enhancement film is applied to the coated surface of the optical film sample with a coating stick of No. 12, and after drying with a UV exposure machine, the film is cross-cut into a hundred squares. A 3M 600 tape is attached to the hundred squares sample and then peeled off for adhesion evaluation.

III. Optical Adhesive Adhesion Test after UV Light Irradiation:

The coated surface of the optical film sample is first exposed to UV light, and after the exposure to energy of 500 mJ/cm², the optical adhesiveness test is sequentially conducted by the aforementioned test method II to evaluate the optical adhesive adhesion.

IV. Filler Particle Dispersion Test of the Coating:

The coating surface of the optical film sample is tested for the dispersion of the filler particle using a Hitachi 55000 scanning electron microscope. The sample is first fixed on a carbon gel, and then a gold or platinum film is plated with a gold plating machine and observed at a test magnification of 10,000 times.

V. Temperature of Anti-Sticking Effect:

The temperature of anti-sticking effect of the coating of the optical film sample is tested by heat sealing test machine, model HST-H3, of WIYI Instrument Company. Two samples of the optical film are taken, and the surfaces of the coated films of the samples are opposed to each other, the heat sealing pressure is 2 MPa, the heat sealing time is 2 minutes, and the adhesion resistance test is performed at different temperatures. After heat sealing, the two samples can be easily separated without leaving traces upon the surfaces thereof, and the temperature at the time is recorded a limit temperature of anti-sticking effect of the optical film samples.

Preparation of acrylate graft modified polyurethane resin

I. Preparation of Prepolymer:

100 g of PTMG2000 (polyether diol, molecular weight 2000), 6.5 g of 1,4-BG (1,4-butanediol, molecular weight 90) are sequentially added to the reactor, and the temperature is raised to 80° C. under constant stirring. Thereafter, 43 g of isophorone diisocyanate is added, the temperature is raised to 85-90° C., and the reaction is carried out at this temperature for 2-3 hours.

II. Dilution and Chain Extension of Prepolymer:

Next, the batch is added with 140 g of methyl methacrylate (MMA), 8 g of 2-hydroxyethyl acrylate (2-HEA), and 4.8 g of ethyl acrylate (EA) to reduce the viscosity, and then an additional 10 g of sodium ethylenediamineethanesulfonate (AAS) is added to the prepolymer and the reaction is continued for 25-40 minutes.

III. Water Dispersion:

After completion of the reaction, the prepolymer obtained in the step II is cooled to room temperature, and 300 g of deionized water is added at 500 rpm, and then 1 g of ethylenediamine is added to carry out chain extension reaction for about 30 minutes to obtain a sulfonate-type aqueous polyurethane emulsion.

IV. Acrylate Synthesis:

4.8 g of emulsifier sodium dodecyl sulfate (SLS) is added to the sulfonate-type aqueous polyurethane emulsion of the step III under rapid stirring, the temperature is raised to 50 to 70° C., followed by dropwise addition of 0.40 g of ammonium persulfate aqueous solution (APS), and then the temperature is raised to 75 to 85° C., and maintained at this temperature for 1 to 3 hours. After the temperature is cooled to 50 to 70° C., 0.12 g of t-butyl hydroperoxide solution (TBHP) and 0.12 g of sodium formaldehyde sulfoxylate (SFS) are added and reacted for 30 minutes to obtain an acrylate graft-modified polyurethane resin.

### First Embodiment

After PET pellets are sufficiently dried, they are fed to an extruder to be melted and extruded, and then cooled and solidified through a cooling cylinder having a surface temperature of 25° C. to obtain an unstretched PET sheet. After heating, the uniaxially stretched PET film is obtained by performing longitudinal uniaxial stretching at a draw ratio of 4 times.

A water-soluble coating liquid obtained by uniformly stirring the following ingredients:
(1) 8.5 g of acrylate graft modified polyurethane resin;
(2) 1.0 g of melamine crosslinking agent;
(3) 2.1 g of filler particle mixture; 0.05 g of anionic surface active agent A, 0.45 g of nonionic surface active agent B, 0.05 g of silicon-containing compound and 1.05 g of high molecular polymer (polyester resin) as a treating agent; 0.10 g of 100 nm silicon oxide particles A and 0.40 g of 30 nm silicon oxide particles B are modified;
(4) 0.1 g of catalyst, 5 g of isopropanol, 1.4 g of butyl cellulose and 0.01 g of a ruthenium or fluorine-containing auxiliary compound; and
(5) 81.89 g of water solvent

The preparation uniaxially stretched PET film is subjected to a one-side coating treatment, and the pre-formed water-soluble coating liquid is uniformly coated on the uniaxially stretched PET film, and then the coated uniaxially stretched PET film is guided to a heating zone of 105° C. with a fixing clip, dried and removed of the moisture of the coating, and then sent to a heating zone of 125° C.; after 3.5 times of lateral extension, a biaxially stretched PET film having a single-sided coating is obtained. Then, it is further treated at 235° C. for 8 seconds to obtain a polyester optical film with a film thickness of 50 μm and having the single-sided coating.

The physical properties of the polyester optical film are tested. The test results are shown in Table 1.

### Second Embodiment

By using the same method as in the first embodiment, a polyester optical film with a film thickness of 50 μm and having the single-sided coating is obtained. However, the water-soluble coating liquid is changed to being formed by uniformly stirring together the following ingredients:
(1) 8.75 g of acrylate graft modified polyurethane resin;
(2) 0.8 g of melamine crosslinking agent;
(3) 1.95 g of filler particle mixture; 0.25 g of anionic surface active agent A, 0.25 g of nonionic surface active agent B, 0.05 g of silicon-containing compound and 1.05 g of high molecular polymer (polyester resin) as a treating agent; 0.10 g of 100 nm silicon oxide particles A and 0.25 g of 30 nm silicon oxide particles B are modified;
(4) 0.1 g of catalyst, 5 g of isopropanol, 1.4 g of butyl cellulose and 0.01 g of a ruthenium or fluorine-containing auxiliary compound; and
(5) 81.89 g of water solvent

The physical properties of the polyester optical film are tested. The test results are shown in Table 1.

### Third Embodiment

Same method as in First embodiment, a polyester optical film with a film thickness of 50 μm and having the single-sided coating is obtained. However, the water-soluble coating liquid is changed to being formed by uniformly stirring together the following ingredients:
(1) 8.0 g of acrylate graft modified polyurethane resin;
(2) 1.0 g of melamine crosslinking agent;
(3) 2.0 g of filler particle mixture; 0.45 g of anionic surface active agent A, 0.05 g of nonionic surface active agent B, 0.05 g of silicon-containing compound and 1.05 g of high molecular polymer (polyester resin) as a treating agent; 0.30 g of 100 nm silicon oxide particles A and 0.1 g of 30 nm silicon oxide particles B are modified;
(4) 0.1 g of catalyst, 5 g of isopropanol, 1.4 g of butyl cellulose and 0.01 g of a ruthenium or fluorine-containing auxiliary compound; and
(5) 81.99 g of water solvent

The physical properties of the polyester optical film are tested. The test results are shown in Table 1.

### Fourth Embodiment

Same method as in First embodiment, a polyester optical film with a film thickness of 50 μm and having the single-sided coating is obtained. However, the water-soluble coating liquid is changed to being formed by uniformly stirring together the following ingredients:
(1) 8.5 g of acrylate graft modified polyurethane resin;
(2) 1.0 g of melamine crosslinking agent;
(3) 2.1 g of filler particle mixture; 0.45 g of anionic surface active agent A, 0.05 g of nonionic surface active agent B, 0.1 g of silicon-containing compound and 1.0 g of high molecular polymer (polyester resin) as a treating agent; 0.40 g of 100 nm silicon oxide particles A and 0.1 g of 30 nm silicon oxide particles B are modified;
(4) 0.1 g of catalyst, 5 g of isopropanol, 1.4 g of butyl cellulose and 0.01 g of a ruthenium or fluorine-containing auxiliary compound; and
(5) 81.89 g of water solvent

The physical properties of the polyester optical film are tested. The test results are shown in Table 1.

### Fifth Embodiment

Same method as in First embodiment, a polyester optical film with a film thickness of 50 μm and having the single-sided coating is obtained. However, the water-soluble coating liquid is changed to being formed by uniformly stirring together the following ingredients:
(1) 8.75 g of acrylate graft modified polyurethane resin;
(2) 0.5 g of melamine crosslinking agent;
(3) 2.1 g of filler particle mixture; 0.05 g of anionic surface active agent A, 0.45 g of nonionic surface active agent B, 0.1 g of silicon-containing compound and 1.0 g of high molecular polymer (polyester resin) as a treating agent; 0.10 g of 100 nm silicon oxide particles A and 0.4 g of 30 nm silicon oxide particles B are modified;
(4) 0.1 g of catalyst, 5 g of isopropanol, 1.4 g of butyl cellulose and 0.01 g of a ruthenium or fluorine-containing auxiliary compound; and
(5) 81.34 g of water solvent

The physical properties of the polyester optical film are tested. The test results are shown in Table 1.

### Sixth Embodiment

Same method as in First embodiment, a polyester optical film with a film thickness of 50 μm and having the single-sided coating is obtained. However, the water-soluble coating liquid is changed to being formed by uniformly stirring together the following ingredients:
(1) 8.0 g of acrylate graft modified polyurethane resin;
(2) 0.5 g of melamine crosslinking agent;
(3) 2.05 g of filler particle mixture; 0.25 g of anionic surface active agent A, 0.25 g of nonionic surface active agent B, 0.1 g of silicon-containing compound and 1.0 g of high molecular polymer (polyester resin) as a treating agent; 0.15 g of 100 nm silicon oxide particles A and 0.3 g of 30 nm silicon oxide particles B are modified;
(4) 0.1 g of catalyst, 5 g of isopropanol, 1.4 g of butyl cellulose and 0.01 g of a ruthenium or fluorine-containing auxiliary compound; and
(5) 81.94 g of water solvent

The physical properties of the polyester optical film are tested. The test results are shown in Table 1.

### Comparative Example 1

Same method as in First embodiment, a polyester optical film with a film thickness of 50 μm and having the single-sided coating is obtained. However, the water-soluble coating liquid is changed to being formed by uniformly stirring together the following ingredients, and the filler particle is not modified:
(1) 8.5 g of acrylate graft modified polyurethane resin;
(2) 1.0 g of melamine crosslinking agent;
(3) 0.4 g of 30 nm silicon oxide particles B;
(4) 0.1 g of catalyst, 5 g of isopropanol, 1.4 g of butyl cellulose and 0.01 g of a ruthenium or fluorine-containing auxiliary compound; and
(5) 83.59 g of water solvent

The physical properties of the polyester optical film are tested. The test results are shown in Table 1.

### Comparative Example 2

Same method as in First embodiment, a polyester optical film with a film thickness of 50 μm and having the single-sided coating is obtained. However, the water-soluble coating liquid is changed to being formed by uniformly stirring together the following ingredients, and the filler particle is not modified:
(1) 8.5 g of acrylate graft modified polyurethane resin;
(2) 1.0 g of melamine crosslinking agent;
(3) 0.10 g of 100 nm silicon oxide particles A and 0.3 gram of 30 nm silicon oxide particles B;
(4) 0.1 g of catalyst, 5 g of isopropanol, 1.4 g of butyl cellulose and 0.01 g of a ruthenium or fluorine-containing auxiliary compound; and
(5) 83.59 g of water solvent

The physical properties of the polyester optical film are tested. The test results are shown in Table 1.

### Comparative Example 3

Same method as in First embodiment, a polyester optical film with a film thickness of 50 μm and having the single-sided coating is obtained. However, the water-soluble coating liquid is changed to being formed by uniformly stirring together the following ingredients:
(1) 8.5 g of acrylate graft modified polyurethane resin;
(2) 0.1 g of melamine crosslinking agent;
(3) 21 g of filler particle mixture; 0.05 g of anionic surface active agent A, 0.45 g of nonionic surface active agent B, 0.05 g of silicon-containing compound and 1.05 g of high molecular polymer (polyester resin) as a treating agent; 0.10 g of 100 nm silicon oxide particles A and 0.40 g of 30 nm silicon oxide particles B are modified;
(4) 0.1 g of catalyst, 5 g of isopropanol, 1.4 g of butyl cellulose and 0.01 g of a ruthenium or fluorine-containing auxiliary compound; and
(5) 82.79 g of water solvent

The physical properties of the polyester optical film are tested. The test results are shown in Table 1.

| | | Embodiment | | | | | | Comparative example | | |
|---|---|---|---|---|---|---|---|---|---|---|
| Unit:weight ratio | | 1 | 2 | 3 | 4 | 5 | 6 | 1 | 2 | 3 |
| Resin | Acrylate graft | 8.50 | 8.75 | 8.00 | 8.50 | 8.75 | 8.00 | 8.50 | 8.50 | 8.50 |
| | modified polyurethane | | | | | | | | | |
| | resin | | | | | | | | | |
| Crosslink- | Melamine system | 1.00 | 0.80 | 1.00 | 0 | 0.50 | 0.50 | 1.00 | 1.00 | 0.10 |
| ing agent | Oxazoline | 0 | 0.50 | 0.50 | 1.00 | 0.80 | 1.00 | 0 | 0 | 0 |
| Solvent | Water | 81.89 | 81.49 | 81.99 | 81.89 | 81.34 | 81.94 | 83.59 | 83.59 | 82.79 |
| Treatment | surface active agent A | 0.05 | 0.25 | 0.45 | 0.45 | 0.05 | 0.25 | — | — | 0.05 |
| agent | surface active agent B | 0.45 | 0.25 | 0.05 | 0.05 | 0.45 | 0.25 | — | — | 0.45 |
| | Silicon compound | 0.05 | 0.05 | 0.05 | 0.10 | 0.10 | 0.10 | — | — | 0.05 |
| | Silicon compound | 1.05 | 1.05 | 1.05 | 1.00 | 1.00 | 1.00 | — | — | 1.05 |
| filler | Particle A | 0.10 | 0.10 | 0.30 | 0.40 | 0.10 | 0.15 | — | 0.10 | 0.10 |
| particle | (particle size 100 nm) | | | | | | | | | |
| | Particle B | 0.40 | 0.25 | 0.10 | 0.10 | 0.40 | 0.30 | 0.40 | 0.30 | 0.40 |
| | (particle size 30 nm) | | | | | | | | | |
| Additive | catalyst | 0.10 | 0.10 | 0.10 | 0.10 | 0.10 | 0.10 | 0.10 | 0.10 | 0.10 |
| | Isopropanol | 5.00 | 5.00 | 5.00 | 5.00 | 5.00 | 5.00 | 5.00 | 5.00 | 5.00 |
| | Butyl cellulose | 1.40 | 1.40 | 1.40 | 1.40 | 1.40 | 1.40 | 1.40 | 1.40 | 1.40 |
| | silicon or fluorine aid | 0.01 | 0.01 | 0.01 | 0.01 | 0.01 | 0.01 | 0.01 | 0.01 | 0.01 |
| Physical | PET film thickness | 50 | 50 | 50 | 50 | 50 | 50 | 50 | 50 | 50 |
| property | (μm) | | | | | | | | | |
| | Coated surface | Single- | Single- | Single- | Single- | Single- | double- | Single- | Single- | Single- |
| | | sided | sided | sided | sided | sided | sided | sided | sided | sided |
| | Light transmittance (%) | 91.25 | 92.11 | 91.05 | 90.48 | 91.15 | 91.18 | 89.95 | 89.88 | 91.23 |
| | Haze (%) | 0.68 | 0.65 | 0.75 | 0.81 | 0.69 | 0.72 | 1.05 | 1.15 | 0.72 |
| | Adhesion to optical | good | good | good | good | good | good | good | good | good |
| | glue | | | | | | | | | |
| | Adhesion to optical | good | good | good | good | good | good | good | good | good |
| | glue after UV light | | | | | | | | | |
| | irradiation | | | | | | | | | |
| | Dispersion of filler | good | good | good | fair | good | good | bad | bad | good |
| | particle | | | | | | | | | |
| | Temperature of anti- | 90 | 90 | 110 | 120 | 90 | 90 | 70 | 80 | 70 |
| | sticking effect (° C.) | | | | | | | | | |

### RESULTS

1. The acrylate graft modified polyurethane resin is added in the coating components of the polyester optical film obtained in the first to the sixth embodiments of the present disclosure. When being used as a backlight module substrate of a liquid crystal display, the coating of the polyester optical film has good adhesion to the optical adhesive and adhesion to the optical adhesive after irradiation with UV light.

In addition, the inorganic particles in the coating components have good dispersion in the coating after the surface modifying agent, so that the polyester optical film has good light transmittance and good haze. Moreover, the inorganic particles in the coating components are mixed with inorganic particles having different particle sizes, which can improve the slipperiness of a PET substrate and at the same time, increase the temperature of anti-sticking effect of the coating of the polyester optical film.

In the coating components of the polyester optical film obtained in Comparative Examples 1 and 2, the inorganic particles are not subjected to surface modification, and the optical transmittance of the polyester optical film product is poor and the haze is also poor.

2. The larger the particle sizes of the inorganic particles in the filler particle mixture are, the higher the temperature of anti-sticking effect of the coating of the polyester optical film is. In the polyester optical film of Comparative Examples 3 and 4, the coating uses inorganic particles having large particle size and the temperature of anti-sticking effect of the coating is up to 100° C. or higher. In contrast, in the polyester optical film of Comparative Example 1, the coating does not use inorganic particles having large particle size, and the surface modifier is not added for modification. Furthermore, the temperature of anti-sticking effect is low, and only reaches 70° C., which is one of the major issues the present disclosure is looking to improve.

3. In the components of the coating of the polyester optical film obtained in Comparative Example 3, inorganic particles having different particle sizes are mixed, a surface modifying agent is added for modification, and the dispersion of the coating is good. However, the additional amount of the crosslinking agent is insufficient, resulting in an incomplete coating reaction, and the temperature of anti-sticking effect is still low.

In conclusion, the coating components of the polyester optical film of the present disclosure is composed of the urethane resin modified by the acrylate graft, the crosslinking agent, the surface-modified inorganic particle solution, and other additives. The coating of the polyester optical film on the polyester optical substrate can significantly improve transparency, haze, adhesion, slippage and anti-stick properties of the polyester optical film.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A water-soluble coating liquid for coating a surface of a polyester film substrate to form a coating, comprising the following components in respective weight ratios, with the sum of the following components being 100 wt %:
(1) 2 to 40 wt % of an acrylate graft-modified polyurethane resin;
(2) 0.5 to 30 wt % of a crosslinking agent;
(3) 0.05 to 30 wt % of filler particle mixture;
(4) 0.05 to 10 wt % of an additive selected from one or any combination of an auxiliary agent, a catalyst and a co-solvent; and
(5) 50 to 85 wt % of water;
wherein the component of the filler particle mixture of the component (3) includes:
a. 20 to 95 wt % of inorganic particles selected from one or any combination of silicon oxide, titanium oxide, aluminum oxide, calcium carbonate, calcium phosphate and barium sulfate; and
b. 0.5 to 30 wt % of surface modifier to modify a surface of the inorganic particles.

2. The water-soluble coating liquid according to claim 1, wherein the inorganic particles of the component (3) have a particle size of from 0.005 to 3 μm.

3. The water-soluble coating liquid according to claim 1, wherein surface-modified inorganic particle concentration is from 0.01% to 6% of the solid content of the water-soluble coating liquid.

4. The water-soluble coating liquid according to claim 1, wherein the acrylate graft-modified polyurethane resin is graft-modified using an acrylate monomer composed of the following components, with the sum of the following components being 100 wt %:
a. 90 to 95 wt % of alkyl group-containing (meth)acrylate;
b. 4 to 9 wt % of hydroxyl group-containing (meth)acrylate; and
c. 1 to 5 wt % of carboxyl group-containing vinyl monomer.

5. The water-soluble coating liquid according to claim 4, wherein the carboxyl group-containing vinyl monomer is selected from one or any combination of acrylic acid, methacrylic acid, itaconic acid, crotonic acid, maleic acid, fumaric acid, and maleic anhydride.

6. The water-soluble coating liquid according to claim 4, wherein the crosslinking agent of the component (2) is selected from one or any combination of melamine crosslinking agent, hydroxymethyl modified melamine derivative crosslinking agent, isocyanate crosslinking agent, aziridine crosslinking agent, oxazoline crosslinking agent and carbodiimide crosslinking agent.

7. The water-soluble coating liquid according to claim 4, wherein the surface modifier of the component (3) is selected from one or any combination of vinyl decane coupling agent, epoxy decane coupling agent, styryl decane coupling agent, methyl propylene decyl decane coupling agent, propylene decyl decane coupling agent, amino decane coupling agent, isocyanurate decane coupling agent, ureido decane coupling agent and isocyanate decane coupling agent.

8. The water-soluble coating liquid according to claim 4, wherein the auxiliary agent in the component (4) is selected from one or any combination of silicon-containing additive, fluorine-containing additive, and additive containing a silicon/fluorine mixed component.

9. The water-soluble coating liquid according to claim 4, wherein the co-solvent in the component (4) is selected from one or any combination of methanol, ethanol, n-propanol, isopropanol, butanol, isobutanol, dimethylhydrazine, acetone and tetrahydrofuran solvent.

10. A polyester optical film having a biaxially stretched polyester film substrate, and one of the surfaces thereof is coated with the water-soluble coating liquid of claim 1.
